(19) United States
(12) Patent Application Publication
(10) Pub. No.: US 2015/0003736 A1
(43) Pub. Date: Jan. 1, 2015

(54) METHOD AND APPARATUS FOR EXTRACTING PATTERN FROM IMAGE

(71) Applicant: ELECTRONICS AND TELECOMMUNICATIONS RESEARCH INSTITUTE, Daejeon (KR)

(72) Inventors: Seung Min CHOI, Daejeon (KR); Jae-Chan JEONG, Daejeon (KR); JAE IL CHO, Jeollanam-do (KR); Dae Hwan HWANG, Jeollanam-do (KR)

(73) Assignee: ELECTRONICS AND TELECOMMUNICATIONS RESEARCH INSTITUTE, Daejeon (KR)

(21) Appl. No.: 14/158,925

(22) Filed: Jan. 20, 2014

(30) Foreign Application Priority Data
Jul. 1, 2013 (KR) 10-2013-0076611

(51) Int. Cl. G06K 9/62; G06T 5/00

(52) U.S. Cl. CPC G06K 9/6217; G06T 5/002; G06T 2207/20182
USPC 382/190

(57) ABSTRACT

An apparatus includes a noise removal block for removing image noise mixed with an input image, a Modified Census Transform (MCT) block for transforming the input image from which the image noise has been removed into a current MCT coefficient, a candidate pattern extraction block for calculating a Sum of Hamming Distance (SHD) value between a current pattern window of the transformed current MCT coefficient and a reference pattern window of a previously registered template image by performing SHD calculation on the two pattern windows and extracting a candidate pattern, and a pattern detection block for scaling down the input image in a predetermined ratio when all pixels of the current scale are processed and detecting a candidate pattern having a minimum SHD value, of stored candidate patterns, as a representative pattern.

### RELATED APPLICATION(S)

This application claims the benefit of Korean Patent Application No. 10-2013-0076611, filed on Jul. 1, 2013, which is hereby incorporated by references as if fully set forth herein.

### FIELD OF THE INVENTION

The present invention relates to a scheme for extracting a pattern from an image and, more particularly, to a method and apparatus for extracting a pattern from an image, which are suitable for extracting a pattern from an image captured by a camera using a stereo matching technique utilizing an active light source, of stereo matching techniques for obtaining a three-dimensional (3-D) space information map.

### BACKGROUND OF THE INVENTION

Recently, active research is being carried out in which a human's gesture (or movement) is sought to be used as an input device, such as a keyboard, a remote controller, or a mouse, by detecting the human's gesture using 3-D information and associating such gesture detection information with a control command for a device.

For example, techniques for various input devices utilizing a human's gesture, that is, gesture recognition devices, such as a gesture recognition device using an attachment type haptic device (e.g., Nintendo Wii), a gesture recognition device using a contact type touch screen (e.g., an electrostatic touch screen by Apple IPAD), and a short-distance contactless type gesture recognition device within several meters (e.g., Kinect device by Microsoft XBOX), have been developed and used in real life.

From among the gesture recognition techniques, an example in which a 3-D scanning method using an existing high-precision machine vision used for the military or factory automation has been applied to common applications is Kinect device by Microsoft. Kinect is a real-time 3-D scanner for projecting a laser pattern of a level Class1 onto a real environment, detecting information on a visual difference for each distance which is generated between a projector and a camera, and converting the detected information into 3-D frame information. Kinect is a product commercialized by Microsoft using a technique owned by Israel Primesense.

Kinect is one of 3-D scanner products that have been most sold ever without any problem in a user's safety. 3-D scanners similar to Kinect and derivative products using the 3-D scanners are actively developed.

FIG. 1 is a conceptual diagram illustrating a Kinect method using a structural light system, and FIG. 2 is a conceptual diagram illustrating an active stereo vision method.

FIG. 1 shows a structural light method that requires a single projection apparatus and a single camera, and FIG. 2 shows an active stereo vision method using a single projection apparatus and a stereo camera.

First, the conventional method of FIG. 1 for obtaining 3-D information using vision includes a step 1-1 of generating and storing a pattern that is a reference, a step 1-2 of projecting the pattern onto the subject using a projector or a diffuser, a step 1-3 of capturing the subject at a projected position at a point spaced apart from the projector by a specific distance (i.e., a baseline), a step 1-4 of extracting a pattern from the captured image, and a step 1-5 of obtaining a visual difference occurring due to a specific distance by matching the extracted pattern with the reference pattern and converting the obtained visual difference into 3-D information.

The conventional method of FIG. 2 showing a procedure of an active stereo vision method is similar to the structural light method of FIG. 1, but is different from the structural light method of FIG. 1 in that it includes elements for a passive stereo vision technique at steps 2-3, 2-4, and 2-5. In particular, a pattern matching work at step 2-5 can be implemented by various combinations, such as a comparison between stereo images or a comparison between a reference pattern and a captured stereo vision.

However, the structural light method of FIG. 1 is problematic in that it is difficult to extract precise depth information (i.e., a precise depth map) in obtaining 3-D information, and the active stereo method of FIG. 2 has a fundamental problem in that it is difficult to be used outdoors.

### SUMMARY OF THE INVENTION

In accordance with the present invention, in obtaining 3-D information, a pattern is extracted from a captured image in the existing structural light method of FIG. 1 and the active stereo vision method of FIG. 2.

In general, in the structural light method of FIG. 1, a pattern is extracted at step subsequent to step 1-4, and the extracted results are compared with the reference pattern at step 1-1. Such a work is performed at step 1-5. Meanwhile, in the active stereo vision method of FIG. 2, a pattern may be extracted at step subsequent to step 2-4 and compared with the reference pattern at step 2-1, and matching may be performed using only two received images at step 2-4 or matching may be performed using only two extracted pattern images. As described above, a pattern extraction work is a very important technique in a structural light technique using active light and an active stereo vision technique. It is however difficult to expect an effect using a method of extracting a pattern only by controlling a threshold because the brightness or size of the pattern may be frequently changed depending on the distance or lighting.

Accordingly, the present invention provides a new scheme which is robust to lighting and the distance in detecting a projected pattern using a laser pattern projection apparatus.

In accordance with an aspect of the present invention, there is provided a method for extracting a pattern from an image, which includes a first process of transforming an input image into a current Modified Census Transform (MCT) coefficient, a second process of configuring a current pattern window of the transformed current MCT coefficient, a third process of calculating a Sum of Hamming Distance (SHD) value between the current pattern window and a reference pattern window of a previously registered template image by performing SHD calculation on the two pattern windows and comparing the calculated SHD value with a predetermined threshold, a fourth process of extracting a corresponding pattern as a candidate pattern if, as a result of the comparison, the calculated SHD value is smaller than the predetermined threshold, a fifth process of moving a center pointer of the current pattern window to a next pixel if, as a result of the comparison, the calculated SHD value is equal to or greater than the predetermined threshold and checking whether or not processing for all pixels of a current scale of the input image has been completed, a sixth process of repeatedly performing the second process to the fifth process until the processing for all the pixels of the current scale is completed, a seventh process of scaling down the input image in a predetermined ratio when the processing for all the pixels of the current scale is completed and checking whether or not processing for all scales of the input image has been completed, an eighth process of repeatedly performing the first process to the seventh process until the processing for all the scales of the input image is completed, and a ninth process of detecting a candidate pattern having a minimum SHD value as a representative pattern by comparing SHD values of stored candidate patterns with each other when the processing for all the scales of the input image is completed.

In the exemplary embodiment, further include a process of removing image noise of the input image before transforming the input image into the current MCT coefficient.

In the exemplary embodiment, the first process may includes transforming each of pixels of the input image into an MCT coefficient domain, determining a block size of MCT calculation, and generating the current MCT coefficient by performing MCT in such a way as to substitute coordinates of an MCT coefficient of a first pixel into a pixel pointer.

In the exemplary embodiment, a size of the current MCT coefficient may be determined to be a size that satisfies both calculation speed and performance.

In the exemplary embodiment, a number of bits of the current MCT coefficient may be determined by the block size of MCT calculation.

In the exemplary embodiment, the MCT calculation may include outputting an MCT coefficient of 9 bits by performing MCT of a 3×3 size.

In the exemplary embodiment, the current pattern window may be configured to have pattern features of the current MCT coefficient.

In the exemplary embodiment, the fourth process may include storing a coordinate value, an SHD value, or a scale step of the candidate pattern.

In the exemplary embodiment, the eighth process may includes designating a first pixel at a left top of a scale image, generated through scale-down, as a pointer and repeatedly performing the first process to the seventh process.

In the exemplary embodiment, the eighth process may be repeatedly performed until a scale image having a predetermined minimum size is output.

In the exemplary embodiment, the ninth process may includes restoring a window size of each of detected candidate patterns to a size of an original image, determining a maximum value ‘Max_left’ of x-axis values on a left side of two restored windows, a minimum value ‘Min_right’ of x-axis values on a right side of the two windows, a maximum value ‘Max_top’ of y-axis values at a top of the two windows, and a minimum value ‘Min_bottom’ of y-axis values at a bottom of the two windows, checking whether or not a condition (‘Max_left’>Min_right) or (‘Max_top’>‘Min_bottom’) is satisfied, calculating a size of an intersection area of the two windows if, as a result of the check, the condition is found to be not satisfied and comparing the size of the intersection area with a predetermined intersection ratio, determining the two windows to be an identical pattern if, as a result of the comparison, the calculated size of the intersection area is found to be greater than the predetermined intersection ratio and determining a candidate pattern having a relatively small SHD value to be a final pattern, and detecting a corresponding pattern as the representative pattern when a number of times that the final pattern has been determined reaches a predetermined reference number.

In accordance with another aspect of the exemplary embodiment of the present invention, there is provided an apparatus for extracting a pattern from an image, which includes a noise removal block for removing image noise mixed with an input image, a Modified Census Transform (MCT) block for transforming the input image from which the image noise has been removed into a current MCT coefficient, a candidate pattern extraction block for calculating a Sum of Hamming Distance (SHD) value between a current pattern window of the transformed current MCT coefficient and a reference pattern window of a previously registered template image by performing SHD calculation on the two pattern windows until all pixels of a current scale of the input image are processed and extracting a candidate pattern by comparing the calculated SHD value with a predetermined threshold, and a pattern detection block for scaling down the input image in a predetermined ratio when all pixels of the current scale are processed and detecting a candidate pattern having a minimum SHD value, of stored candidate patterns, as a representative pattern when processing for all scales of the input image is completed.

In the exemplary embodiment, the MCT transform block may includes a domain transform unit for transforming each of the pixels of the input image into an MCT coefficient domain, a block determination unit for determining a block size necessary for MCT calculation for the transformed MCT coefficient domain, and a coefficient generation unit for generating the current MCT coefficient by performing MCT in unit of the determined block size.

In the exemplary embodiment, the block determination unit may determines the current MCT coefficient to have a size that satisfies both calculation speed and performance.

In the exemplary embodiment, a number of bits of the current MCT coefficient may be determined by the block size of MCT calculation.

In the exemplary embodiment, the coefficient generation unit may outputs an MCT coefficient of 9 bits by performing MCT of a 3×3 size.

In the exemplary embodiment, the candidate pattern extraction block may includes a window configurator for configuring the current pattern window of the transformed current MCT coefficient, an SHD calculator for calculating the SHD value between the two pattern windows by performing the SHD calculation on the current pattern window and the reference pattern window, a candidate pattern extractor for extracting a corresponding pattern as a candidate pattern if the calculated SHD value is smaller than the predetermined threshold, and a candidate pattern administrator for moving a center pointer of the current pattern window to a next pixel if the calculated SHD value is equal to or greater than the predetermined threshold and instructing SHD values to be calculated and candidate patterns to be extracted until all the pixels of the current scale of the input image are processed.

In the exemplary embodiment, the window configurator may configures the current pattern window having a size that comprises pattern features of the current MCT coefficient.

In the exemplary embodiment, the pattern detection block may includes a scale-down executor for scaling down the input image in a predetermined ratio when the processing for all the pixels of the current scale is completed, and a pattern detector for detecting the candidate pattern having the minimum SHD value as the representative pattern by comparing SHD values of the stored candidate patterns with each other when the scale-down processing for all the scales is completed.

In the exemplary embodiment, the pattern detector may includes an image restoration unit for restoring a window size of each of detected candidate patterns to a size of an original image, a reference value determination unit for determining a maximum value ‘Max_left’ of x-axis values on a left side of two restored windows, a minimum value ‘Min_right’ of x-axis values on a right side of the two windows, a maximum value ‘Max_top’ of y-axis values at a top of the two windows, and a minimum value ‘Min_bottom’ of y-axis values at a bottom of the two windows, an intersection area calculation unit for calculating a size of an intersection area of the two windows if the maximum value ‘Max_left’ is smaller than the minimum value ‘Min_right’ or the maximum value ‘Max_top’ is smaller than the minimum value ‘Min_bottom’, a final pattern determination unit for determining the two windows to be an identical pattern if the calculated size of the intersection area is greater than a predetermined intersection ratio and determining a candidate pattern having a relatively small SHD value to be a final pattern, and a representative pattern determination unit for detecting a corresponding pattern as the representative pattern when a number of times that the final pattern has been determined reaches a predetermined reference number.

### BRIEF DESCRIPTION OF THE DRAWINGS

The objects and features of the present invention will become apparent from the following description of embodiments given in conjunction with the accompanying drawings, in which:

FIG. 1 is a conceptual diagram illustrating a Kinect method using a structural light system;

FIG. 2 is a conceptual diagram illustrating an active stereo vision method;

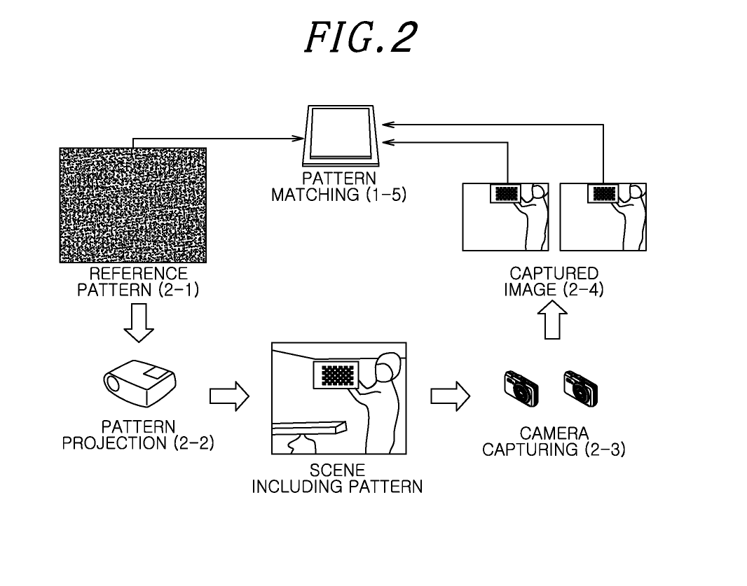

FIG. 3 is a block diagram of an apparatus for extracting a pattern from an image in accordance with an embodiment of the present invention;

FIG. 4 is a detailed block diagram of an MCT transform block shown in FIG. 3;

FIG. 5 is a detailed block diagram of a candidate pattern extraction block shown in FIG. 3;

FIG. 6 is a detailed block diagram of a pattern detection block shown in FIG. 3;

FIG. 7 is a detailed block diagram of a pattern detector shown in FIG. 6;

FIG. 8 is a flowchart illustrating major processes of detecting an image pattern in accordance with an embodiment of the present invention;

FIG. 9 is a flowchart illustrating a detailed process of step 804 shown in FIG. 8;

FIG. 10 is a flowchart illustrating major processes of configuring a reference pattern window based on a template image;

FIG. 11 is a flowchart illustrating a detailed process of step 824 shown in FIG. 8;

FIG. 12 is an exemplary diagram showing screens on which the original image of a pattern and an enlarged image of the original, captured by a camera, are displayed;

FIG. 13 is an exemplary diagram showing screens on an MCT coefficient image obtained by transforming an input image into an MCT coefficient and an enlarged image of the MCT coefficient image;

FIG. 14 is an exemplary diagram of a template having a 2-D Gaussian pattern shape;

FIG. 15 is an exemplary diagram of a pyramid image for the original image using scale-down;

FIG. 16 is an exemplary diagram of screens on a detection pattern including an intersection area and an enlarged pattern of the detection pattern;

FIG. 17 is an exemplary diagram illustrating an intersection area; and

FIG. 18 is an exemplary diagram of screens on a detection pattern not including an intersection area and an enlarged pattern of the detection pattern.

### DETAILED DESCRIPTION OF THE EMBODIMENTS

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the claims.

In describing the embodiments of the present invention, a detailed description of known functions or constructions related to the present invention will be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

Hereinafter, embodiments of the present invention will be described in detail with reference to the accompanying drawings which form a part hereof.

The present invention includes a technical spirit for extracting a projected laser pattern using Modified Census Transform (MCT) and Sum of Hamming Distance (SHD). MCT is chiefly used for image processing in a feature extraction field. If MCT is used to extract a projected laser pattern, a pattern having excellent performance can be extracted with no great influence on the projection distance and lighting.

That is, assuming that an already known pattern and two patterns inputted to a current image (i.e., a stereo image) are present, if MCT is applied to each of the patterns, a window having a size that may include a pattern size is set, and SHD between the two patterns is calculated, the physical meaning of the calculated SHD value is an inverse number of similarity of a shape of a currently inputted pattern for a shape of the already known pattern.

Accordingly, there is a high probability that a window at a currently inputted point may include a pattern as an SHD value is reduced. A pattern having high reliability can be detected by calculating a threshold for determining similarity through various experiments, determining the threshold to be a criterion for pattern detection, determining a large and small relationship between the threshold and an SHD value, and setting a pattern having a minimum SHD, of redundantly found patterns, as a representative pattern.

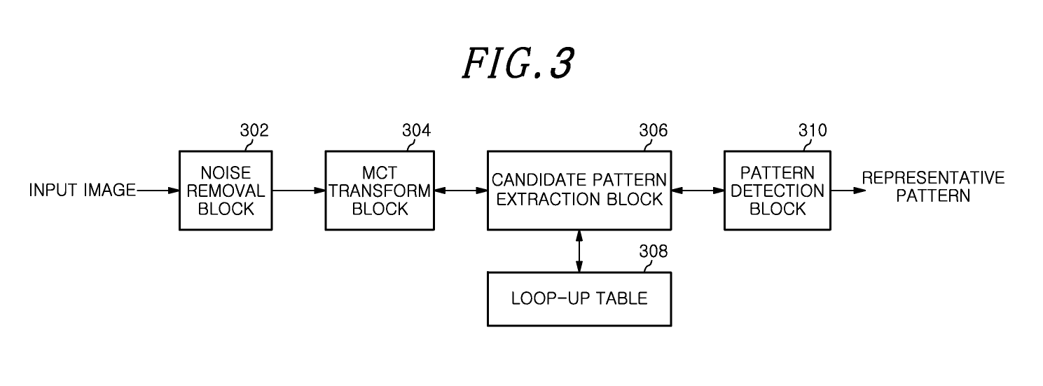

FIG. 3 is a block diagram of an apparatus for extracting a pattern from an image in accordance with an embodiment of the present invention. The apparatus for extracting a pattern from an image may include a noise removal block 302, an MCT transform block 304, a candidate pattern extraction block 306, a loop-up table 308, and a pattern detection block 310.

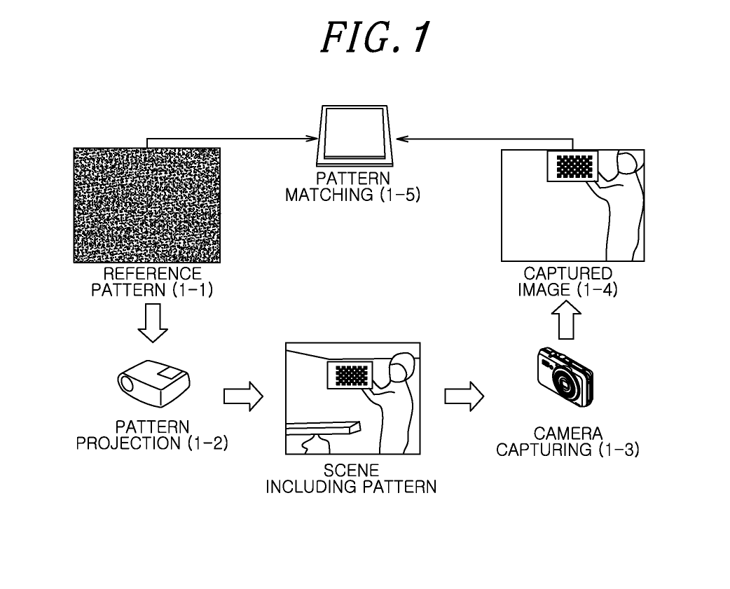

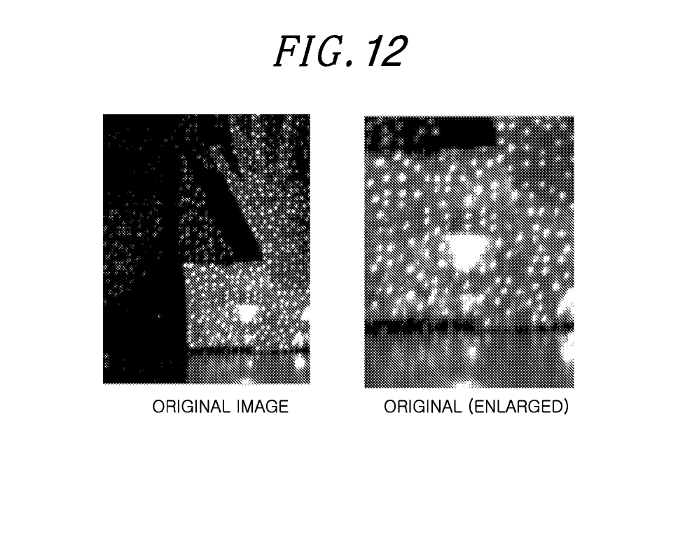

Referring to FIG. 1, the noise removal block 302 can perform a function of removing image noise (or noise) generated when an image is captured by a camera when the original image, for example, the original image, such as that shown in FIG. 12 is received through a camera for photographing the subject using a CMOS module or a CCD module. Removing image noise is for preventing an error of MCT from occurring due to the image noise. In this case, various methods widely known in the art may be used as a method of removing image noise. In FIG. 12, the left figure shows the original image, and the right figure shows an enlarged image.

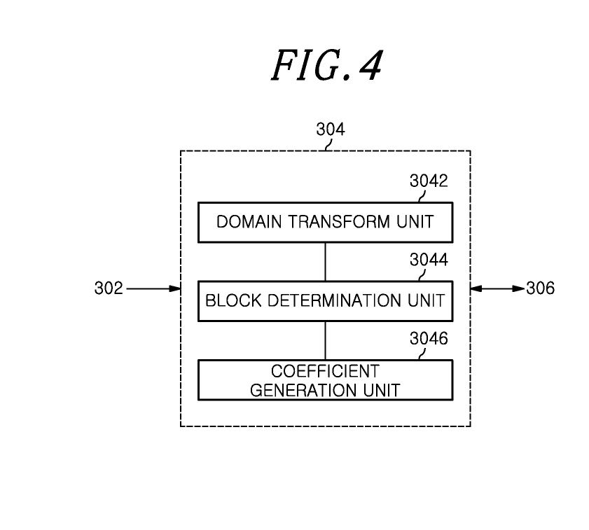

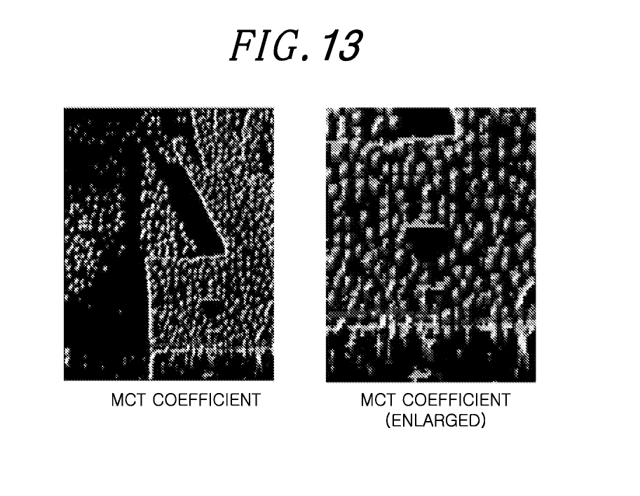

The MCT transform block 304 can perform a function of transforming the input image (i.e., a current image) from which image noise has been removed into an MCT coefficient (i.e., a current MCT coefficient), for example, an MCT coefficient as shown FIG. 13. To this end, the MCT transform block 304 may include elements, such as those of FIG. 4. In FIG. 13, the left figure shows the MCT coefficient of the original image, and the right figure shows the MCT coefficient of the enlarged image.

FIG. 4 is a detailed block diagram of the MCT transform block 304 shown in FIG. 3. The MCT transform block 304 may include a domain transform unit 3042, a block determination unit 3044, and a coefficient generation unit 3046.

Referring to FIG. 4, the domain transform unit 3042 can provide a function of transforming each of the pixels of an input image (or a scaled-down image) into an MCT coefficient domain. That is, the domain transform unit 3042 can provide a function of transforming the pixel into an MCT coefficient domain, using MCT.

The block determination unit 3044 can provide a function of determining the size of a block for MCT calculation for the MCT coefficient domain transformed by the domain transform unit 3042. That is, the block determination unit 3044 can provide a function of setting a block having a size that includes the features of a pattern for an MCT coefficient.

The coefficient generation unit 3046 can perform a function of generating a current MCT coefficient by performing MCT in unit of the block size that has been determined by the block determination unit 3044. Here, the number of bits of the current MCT coefficient depends on the block size of MCT calculation. For example, an MCT coefficient of 9 bits may be output by performing MCT of a 3×3 size which may satisfy both calculation speed and performance.

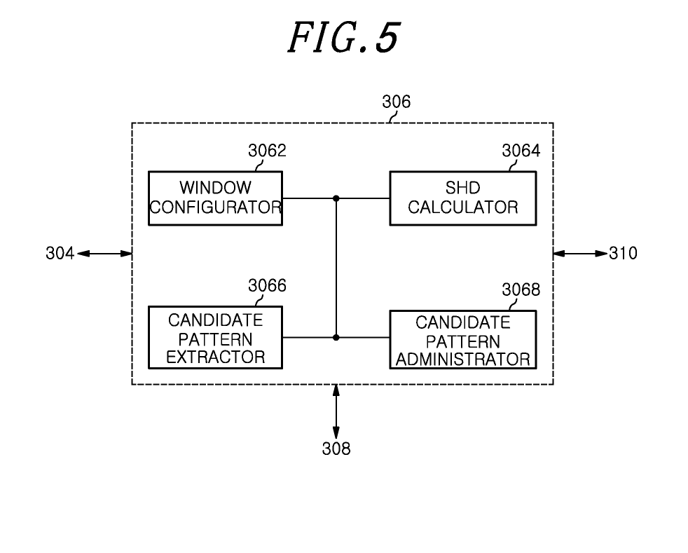

Referring back to FIG. 3, the candidate pattern extraction block 306 can perform a function of calculating an SHD value between a current pattern window of the transformed current MCT coefficient and a reference pattern window of an already registered template image, received from the loop-up table 308, by performing SHD calculation on the two pattern windows, extracting candidate patterns by comparing the calculated SHD value with a predetermined threshold, and storing the extracted candidate patterns, until all the pixels for the current scale of the input image are processed. To this end, the candidate pattern extraction block 306 may include elements, such as those of FIG. 5. The candidate pattern may be a coordinate value, an SHD value (or SHD energy value), or a scale step and may be stored in memory.

FIG. 5 is a detailed block diagram of the candidate pattern extraction block 306 shown in FIG. 3. The candidate pattern extraction block 306 may include a window configurator 3062, an SHD calculator 3064, a candidate pattern extractor 3066, and a candidate pattern administrator 3068.

Referring to FIG. 5, the window configurator 3062 can provide a function of configuring a current pattern window of a transformed current MCT coefficient, for example, a current pattern window having a size which includes the pattern features of a current MCT coefficient.

The SHD calculator 3064 can provide a function of calculating an SHD value between the current pattern window configured by the window configurator 3062 and a reference pattern window received from the loop-up table 308 by performing SHD calculation on the two pattern windows.

A template image that represents a projection light source and the features of a pattern is transformed into an MCT coefficient through the execution of MCT, configured in a reference pattern window (N×M) of a size which includes the features of a pattern, and stored in the loop-up table 308.

That is, when a template on which a light source and a shape of a pattern are recorded is provided as a template image, for example, in the case of a pattern generated after a laser light source passes through a Diffraction Optical Element (DOE), the template has a shape of a Gaussian form. A shape of a pattern may vary depending on the resolution and photographing characteristics of a camera that is used in photographing in addition to a light source and a DOE. In the present invention, a system for photographing a laser pattern having a 2-D Gaussian pattern shape is described as an example.

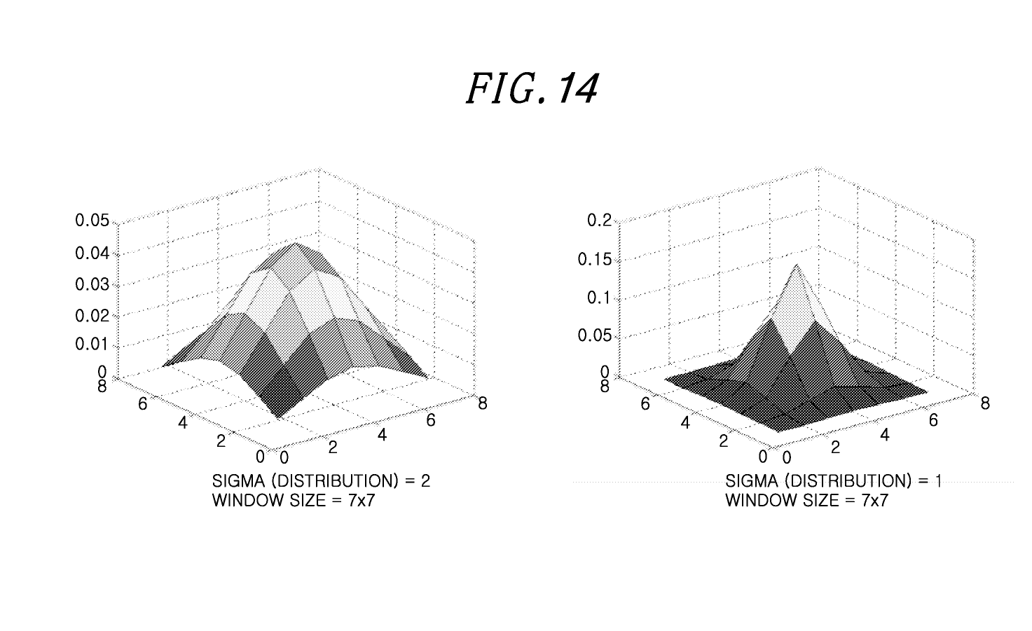

FIG. 14 is an exemplary diagram of a template having a 2-D Gaussian pattern shape. In an embodiment of the present invention, a Gaussian pattern template having a sigma (distribution) value of 1 in a plane including a pixel of a 7×7 size in x and y directions was used as a template image (the same MCT results will be subsequently obtained although any average value of a Gaussian function is used because MCT is used). Here, the size of a plane, a sigma value, etc. can be obtained through experiments. For example, the average characteristics of a photographed pattern have only to be selected by taking a laser light source, a diffuser lens, a photographing system, and photographing resolution into consideration.

Next, the received template image is changed into a feature value (i.e., an MCT coefficient) robust to lighting by performing MCT on the received template image. That is, the pixel is transformed into an MCT coefficient domain using MCT. Here, the number of bits of the MCT coefficient may depend on a block size of MCT calculation. In the present embodiment, an MCT coefficient of 9 bits is output by performing MCT of a 3×3 size which satisfies both calculation speed and performance.

Furthermore, a reference pattern window having a proper size is configured by taking the size of a pattern into consideration. That is, a pattern window having a size (e.g., a window of a 5×5 size) suitable for the MCT coefficient is configured, and the configured pattern window is defined as a kernel LUT. The kernel LUT is stored in the loop-up table 308.

The candidate pattern extractor 3066 can provide a function of comparing the SHD value calculated by the SHD calculator 3064 with a predetermined threshold and extracting a corresponding pattern as a candidate pattern if, as a result of the comparison, the SHD value is found to be smaller than the predetermined threshold. The predetermined threshold may be a threshold obtained through many experiments.

The candidate pattern administrator 3068 can provide a function of moving the center pointer of the current pattern window to a next pixel if the candidate pattern extractor 3066 notifies the candidate pattern administrator 3068 that the calculated SHD value is greater than the predetermined threshold and instructing the SHD calculator 3064 and the candidate pattern extractor 3066 to calculate an SHD value and to extract a candidate pattern until all the pixels for the current scale of the input image are processed.

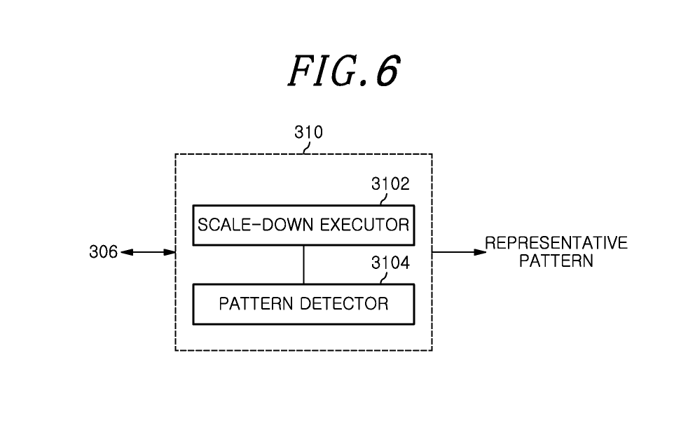

Referring back to FIG. 3, the pattern detection block 310 can provide a function of scaling down the input image in a predetermined ratio when all the pixels for the current scale are processed and detecting a candidate pattern having a minimum SHD value, of stored candidate patterns, as a representative pattern when processing on all the scales of the input image is completed. To this end, the pattern detection block 310 may include elements, such as those of FIG. 6, for example.

FIG. 6 is a detailed block diagram of the pattern detection block 310 shown in FIG. 3. The pattern detection block 310 may include a scale-down executor 3102 and a pattern detector 3104.

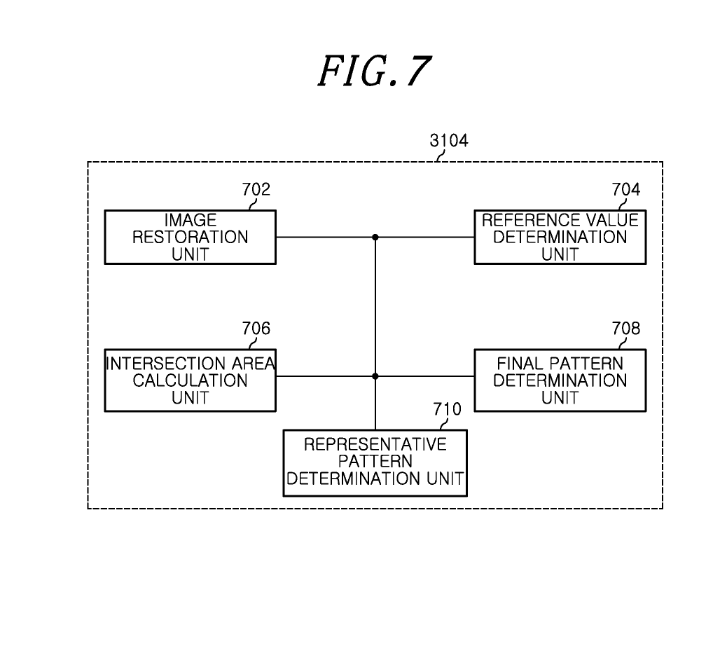

Referring to FIG. 6, the scale-down executor 3102 can provide a function of scaling down an input image in a predetermined ratio when processing on all the pixels of a current scale is completed. The pattern detector 3104 can provide a function of detecting a candidate pattern having a minimum SHD value as a representative pattern by comparing SHD values of stored candidate patterns with each other when scale-down processing for all scales is completed. To this end, the pattern detector 3104 may include elements, such as those of FIG. 7, for example.

FIG. 7 is a detailed block diagram of the pattern detector 3104 shown in FIG. 6. The pattern detector 3104 may include an image restoration unit 702, a reference value determination unit 704, an intersection area calculation unit 706, a final pattern determination unit 708, and a representative pattern determination unit 710.

Referring to FIG. 7, the image restoration unit 702 can provide a function of restoring the window size (i.e., a pattern window size) of each of candidate patterns, detected and stored in memory, into the size of the original image.

The reference value determination unit 704 can provide a function of determining a maximum value ‘Max_left’ of x-axis values on the left side of two restored windows, a minimum value ‘Min_right’ of x-axis values on the right side of the two restored windows, a maximum value ‘Max_top’ of y-axis values at the top of the two restored windows, a minimum value ‘Min_bottom’ of y-axis values at the bottom of the two restored windows and transferring the maximum value ‘Max_left’, the minimum value ‘Min_right’, the maximum value ‘Max_top’, and the minimum value ‘Min_bottom’ to the intersection area calculation unit 706.

The intersection area calculation unit 706 can provide a function of calculating a size of the intersection area of the two windows if the maximum value ‘Max_left’ of the x-axis values on the left side of the two windows is smaller than the minimum value ‘Min_right’ of the x-axis values on the right side of the two windows or if the maximum value ‘Max_top’ of the y-axis values at the top of the two windows is smaller than the minimum value ‘Min_bottom’ of the y-axis values at the bottom of the two windows and determining a pattern area to be another pattern area not having an intersection area if the condition, that is, the condition (‘Max_left’>Min_right) or (‘Max_top’>‘Min_bottom’) is satisfied.

The final pattern determination unit 708 can provide a function of comparing the calculated size of the intersection area, received from the intersection area calculation unit 706, with a predetermined intersection ratio, determining the two pattern windows to be the same pattern if, as a result of the comparison, the calculated size of the intersection area is found to be greater than the predetermined intersection ratio, and determining a candidate pattern having a relatively small SHD value to be a final pattern.

The representative pattern determination unit 710 can provide a function of increasing the number of times (i.e., an intersection count value) that the final pattern has been determined by ‘1’ when the final pattern determination unit 708 notifies the final pattern, checking whether or not an accumulated intersection count value (i.e., the accumulated number of times that the final pattern has been determined) reaches a predetermined reference number (e.g., 3 times), detecting a corresponding pattern as a representative pattern if, as a result of the check, the accumulated intersection count value is found to have reached the predetermined reference number, and outputting the representative pattern. The representative pattern may be output as a coordinate value or a scale step.

A series of processes of extracting a pattern from a stereo image received through a projector using the apparatus for extracting a pattern from an image in accordance with the present invention are described below.

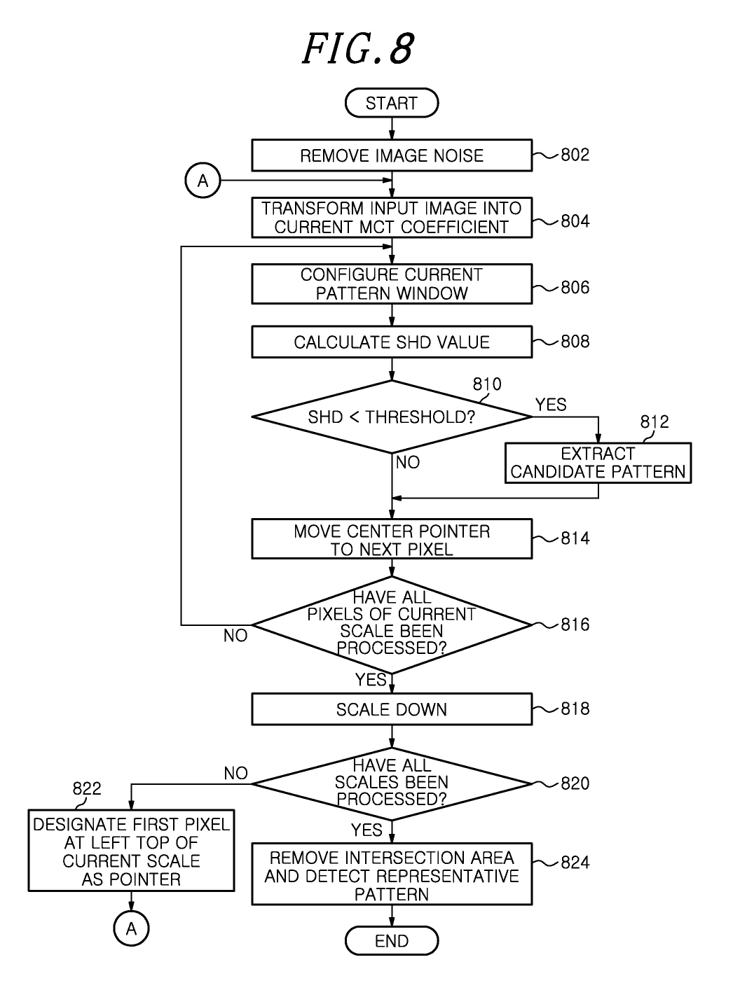

FIG. 8 is a flowchart illustrating major processes of detecting an image pattern in accordance with an embodiment of the present invention.

Referring to FIG. 8, when the original image (e.g., an image having a pattern, such as that of FIG. 12) obtained by photographing a pattern using a camera is received, the noise removal block 302 removes noise, generated when photographing the pattern using a camera, from the original image at step 802. The noise is removed in order to prevent an error from occurring in MCT due to the noise. A variety of widely known methods may be used as a method of removing noise.

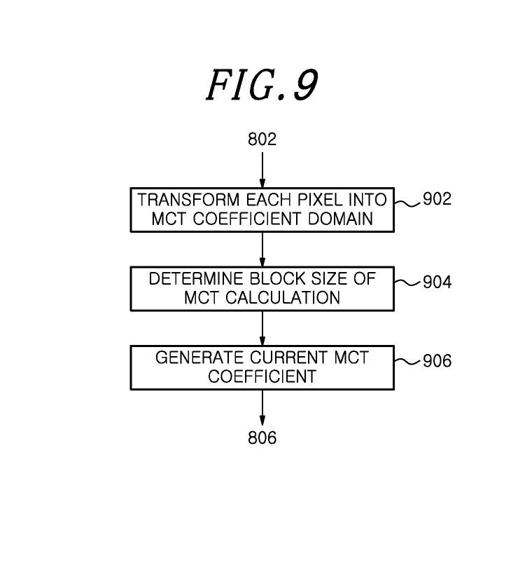

Next, the MCT transform block 304 transforms the input image (i.e., a current image) into a current MCT coefficient, for example, a current MCT coefficient shown in FIG. 13 at step 804. To this end, step 804 may include detailed steps, such as those of FIG. 9.

FIG. 9 is a flowchart illustrating a detailed process of step 804 shown in FIG. 8.

Referring to FIG. 9, the domain transform unit 3042 transforms each of the pixels of the input image (or a scaled-down image) into an MCT coefficient domain using MCT at step 902. The block determination unit 3044 determines a block size (i.e., a size including the features of a pattern for the MCT coefficient) necessary for MCT calculation for the transformed MCT coefficient domain at step 904. The coefficient generation unit 3046 generates a current MCT coefficient by performing MCT in unit of the determined in unit of the determined block size, for example, generates an MCT coefficient of 9 bits by performing MCT of a 3×3 size at step 906. A subsequent process proceeds to step 806 of FIG. 8.

Referring back to FIG. 8, the window configurator 3062 of the candidate pattern extraction block 306 configures a current pattern window of the transformed current MCT coefficient, for example, sets a current pattern window having a size which including the pattern features of the current MCT coefficient at step 806.

The SHD calculator 3064 calculates an SHD value (or SHD energy value) by performing SHD calculation on the configured current pattern window and a reference pattern window, received from the loop-up table 308, at step 808.

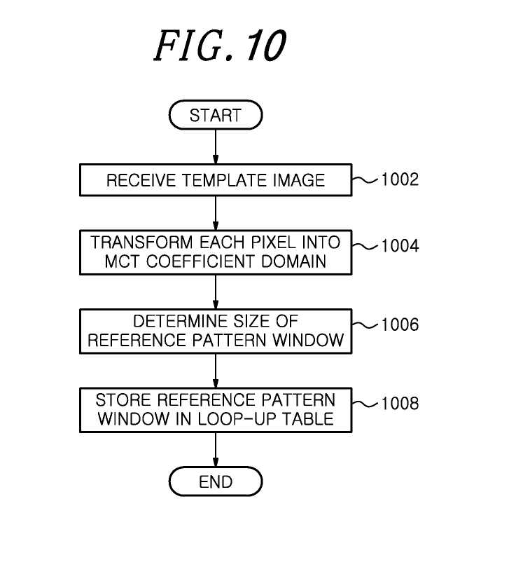

FIG. 10 is a flowchart illustrating major processes of configuring a reference pattern window based on a template image.

Referring to FIG. 10, when a template image is received at step 1002, the received template image is changed into a feature value (i.e., an MCT coefficient) robust to lighting by performing MCT on the received template image. That is, a pixel is changed into an MCT coefficient domain using MCT at step 1004.

A reference pattern window having a proper size is configured by taking the size of a pattern into consideration. That is, a reference pattern window having a size suitable for the MCT coefficient, for example, a window of a 5×5 size at step 1006. The configured reference pattern window is stored in the loop-up table 308 as a kernel LUT at step 1008.

Referring back to FIG. 8, the candidate pattern extractor 3066 compares the SHD value calculated by the SHD calculator 3064 with a predetermined threshold at step 810. In accordance with the present invention, whether or not a pattern is present at a corresponding pixel location can be determined through step 810.

If, as a result of the comparison at step 810, the calculated SHD value is found to be equal to or greater than the predetermined threshold, the process proceeds to step 814. If, as a result of the comparison at step 810, the calculated SHD value is found to be smaller than the predetermined threshold, the candidate pattern extractor 3066 extracts the corresponding pattern as a candidate pattern and stores a result value (e.g., a coordinate value, an SHD value, or a scale step) of the corresponding pattern in the memory at step 812. A subsequent process proceeds to step 814.

Next, step 816 checks whether or not processing for all the pixels of the current scale of the input image has been completed. If, as a result of the check at step 816, processing for all the pixels of the current scale of the input image is found not to have been completed, the process returns to step 806 and the processes subsequent to step 806 are repeatedly performed. That is, step 806 to step 816 are repeatedly performed until all the pixels of the current scale are processed.

Thereafter, if a candidate pattern is extracted or it is notified that the calculated SHD value is equal to or greater than the predetermined threshold, the candidate pattern administrator 3068 moves the center pointer of the current pattern window to a next pixel at step 814 and checks whether or not processing on all the pixels for the current scale of the input image has been completed at step 816. If, as a result of the check at step 816, processing on all the pixels for the current scale of the input image is found to not have been completed, the process returns to step 806, and the processes subsequent to step 806 are repeatedly performed. That is, step 806 to step 816 are repeatedly performed until all the pixels of the current scale are processed. That is, at step 814, the coordinates of the first pixel, that is, the coordinates of the MCT coefficient of the first pixel, are substituted into the pixel pointer so that the current scale image can be used in the loop of step 806 to step 812.

If, as a result of the check at step 816, processing on all the pixels for the current scale of the input image is found to have been completed, the scale-down executor 3102 of the pattern detection block 3110 scales down the input image in a predetermined ratio at step 818.

For example, assuming that the input image has a 640×480 size, if the input image is scaled down in a ratio of 10%, the input image may be scaled down into resolution, such as Table 1 below.

TABLE 1

| WIDTH | HEIGHT | SCALE-DOWN STEP |
|---|---|---|
| 640 | 480 | 0 |
| 576 | 432 | 1 |
| 518 | 389 | 2 |
| 467 | 350 | 3 |
| 420 | 315 | 4 |
| 378 | 283 | 5 |
| 340 | 255 | 6 |
| 306 | 230 | 7 |
| 275 | 207 | 8 |

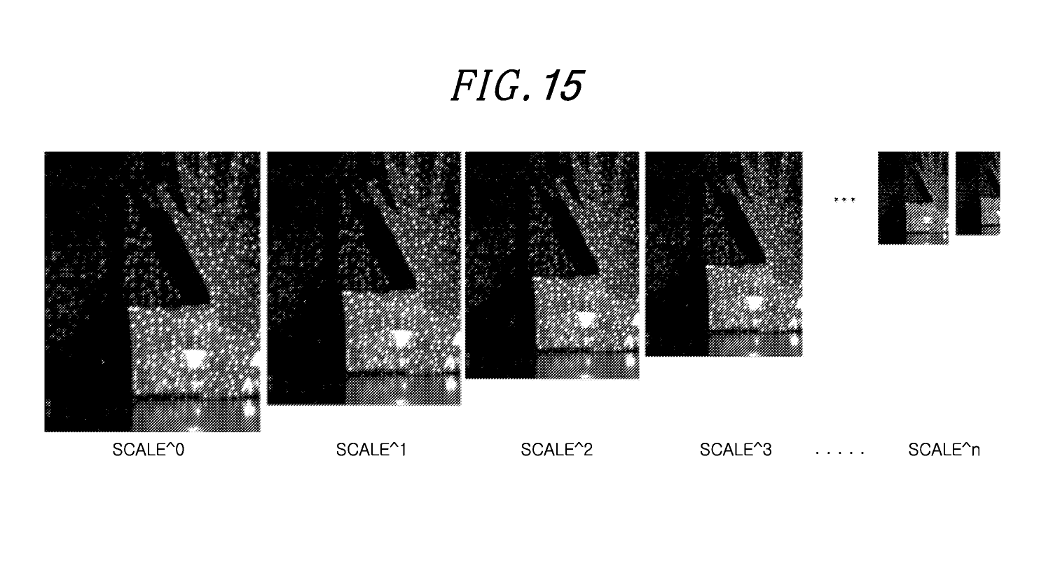

Thereafter, the pattern detector 3104 checks whether or not processing for all the pixels of all the scales of the current image has been completed at step 820. If, as a result of the check at step 820, processing for all the pixels of all the scales of the current image is found to not have been completed, the process proceeds to step 822. Next, the first pixel at the left top of the current scale (i.e., the scale-down image) generated through scale-down is designated as a pointer at step 822, the process returns to step 804, and the processes subsequent to step 804 are repeatedly performed. That is, a minimum size to be scaled down is determined, and step 804 to step 822 are then repeatedly performed until a corresponding scale-down image is obtained. For example, as shown in FIG. 15, a pyramid image for the original image may be generated thus such steps.

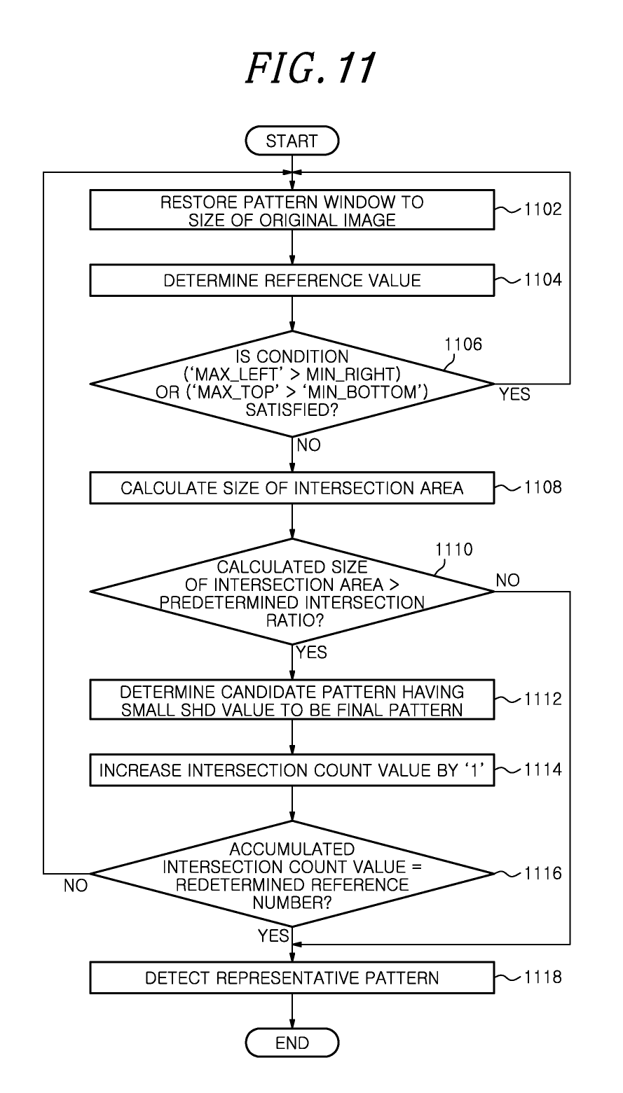

If, as a result of the check at step 820, processing for all the pixels of all the scales of the current image is found to have been completed, the process proceeds to step 824 in which an intersection area is removed and a representative pattern is detected. Step 824 is described in detail with reference to FIG. 11.

FIG. 11 is a flowchart illustrating a detailed process of step 824 shown in FIG. 8.

Referring to FIG. 11, if processing for all the pixels of all the scales has been completed through the series of processes and the process exits from the loop, an arrangement of coordinate values and SHD values (or SHD energy values) of the candidate patterns extracted and stored at step 812 is output. If the arrangement is represented as a figure, a detection pattern having a shape, such as that of FIG. 1, that is, a detection pattern including an intersection, is obtained.

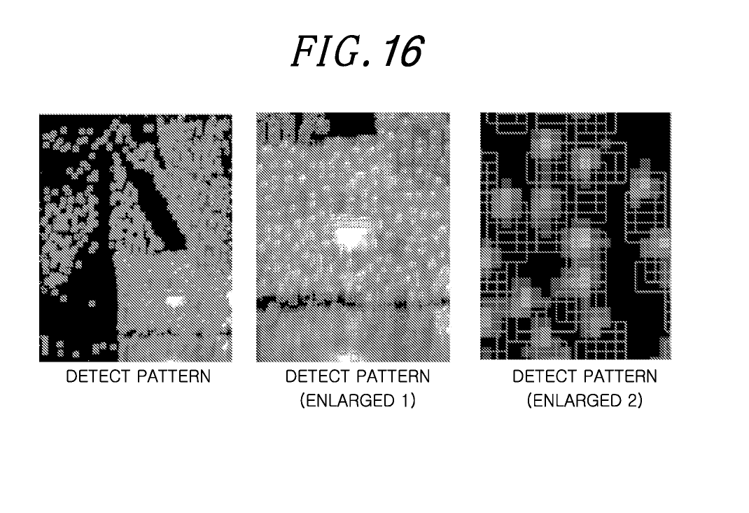

In FIG. 16, a red box indicates information on x, y coordinates at a position where a pattern is determined to be present in the original image through the aforementioned processing process. The SHD values and the scale steps are not shown in FIG. 16, for simplicity.

In the results of FIG. 16, a unique phenomenon is that several windows (i.e., candidate patterns) are drawn in each pattern. Such a phenomenon can be solved by controlling the threshold of the SHD energy value at step 810. If the threshold is set relatively high, the number of intersecting windows is reduced, whereas the number of patterns that is not detected is increased. If the threshold is set relatively low, most of patterns can be detected, but many intersecting windows are stored for each pattern. Accordingly, there is a problem in that what coordinates of the stored windows will be selected. Such a problem can be processed by processes shown in FIG. 11.

That is, in the present invention, several intersecting results are received for each pattern, and each of the received intersecting results is compared with an SHD value (i.e., an SMD energy value) recorded for each window. A window (i.e., a candidate pattern) having a minimum SHD value, of the windows, is set as the representative pattern of a corresponding pattern, and the remaining windows are treated as being invalid. That is, in the present invention, an area intersected as described above is defined as an intersection area, and a window having the lowest SHD energy value, of windows having intersected areas, is set as a representative pattern, which is called the removal of an intersection area.

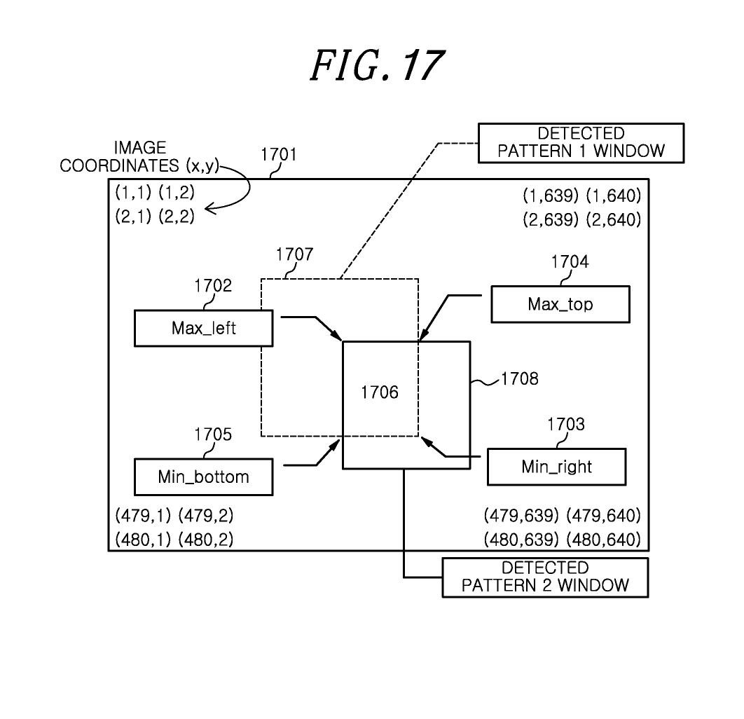

FIG. 17 is an exemplary diagram illustrating an intersection area, and FIG. 11 is a flowchart illustrating major processes of detecting a representative pattern based on an intersection area.

Referring to FIG. 17, reference numeral 1701 indicates an input image, 1707 indicates a window of a detected pattern 1, 1708 indicates a window of a detected pattern 2, 1702 ‘Max_left’ indicates a maximum value of x-axis values on the left side of two windows, 1703 ‘Min_right’ indicates a minimum value of x-axis values on the right side of the two windows, 1704 ‘Max_top’ indicates a maximum value of y-axis values at the top of the two windows, and 1705 ‘Min_bottom’ indicates a minimum value of y-axis values at the bottom of the two windows.

That is, FIG. 17 shows an example in which two intersected patterns are detected. The example shows a case where a single pattern is detected in each of the two windows, and 1705 is assumed to be detected in a scale image larger than that of 1706. For example, assuming that the input image 1701 has 640*480 resolution, coordinates at the left top are (1,1), and coordinates at the right bottom are (640,480), the parameters of 1702 to 1705 may be defined as in Table 2 below. If the four parameters are obtained, a square window having an intersection area can be obtained.

TABLE 2

| NUMBER | PARAMETER NAME | DEFINITION |
|---|---|---|
| 1702 | Max_left | A maximum value of x-axis |
| | | values on the left side of two |
| | | windows |
| 1703 | Min_right | A minimum value of x-axis |
| | | values on the right side of |
| | | two windows |
| 1704 | Max_top | A maximum value of y-axis |
| | | values at the top of two |
| | | windows |
| 1705 | Min_bottom | A minimum value of y-axis |
| | | values at the bottom of two |
| | | windows |

Referring back to FIG. 11, the image restoration unit 702 restores the window size (i.e., a pattern window size) of each of the candidate patterns, detected and stored in the memory, into the size of the original image at step 1102. That is, the image restoration unit 702 removes a scale-down effect from the candidate patterns.

Next, the reference value determination unit 704 determines a maximum value ‘Max_left’ of x-axis values on the left side of two restored windows, a minimum value ‘Min_right’ of x-axis values on the right side of the two windows, a maximum value ‘Max_top’ of y-axis values at the top of the two windows, a minimum value ‘Min_bottom’ of y-axis values at the bottom of the two windows at step 1104.

The intersection area calculation unit 706 checks whether or not the condition (‘Max_left’>Min_right) or (‘Max_top’>‘Min_bottom’) is satisfied at step 1106. If, as a result of the check at step 1106, the condition is found to be satisfied, the intersection area calculation unit 706 determines the corresponding pattern to be another pattern area because an intersection area is not present.

If, as a result of the check at step 1106, the condition is found to be not satisfied, that is, if the maximum value ‘Max_left’ of the x-axis values on the left side of the two windows is equal to or smaller than the minimum value ‘Min_right’ of the x-axis values on the right side of the two windows or the maximum value ‘Max_top’ of the y-axis values at the top of the two windows is equal to or smaller than the minimum value ‘Min_bottom’ of the y-axis values at the bottom of the two windows, the intersection area calculation unit 706 calculates the size of the intersection area of the two windows at step 1108.

The final pattern determination unit 708 compares the calculated size of the intersection area with a predetermined intersection ratio at step 1110. If, as a result of the comparison, the calculated size of the intersection area is found to be equal to or smaller than the predetermined intersection ratio, the process directly proceeds to step 1118.

If, as a result of the comparison at step 1110, the calculated size of the intersection area is greater than the predetermined intersection ratio, the final pattern determination unit 708 determines the two windows to be the same pattern. The final pattern determination unit 708 compares SHD values of the two windows with each other and determines a candidate pattern (i.e., a window) having a relatively small SHD value to be the final pattern as a result of the comparison at step 1112.

Thereafter, when the final pattern is notified, the representative pattern determination unit 710 increases an intersection count value (i.e., the accumulated number of times that the final pattern has been determined) by ‘1’ at step 1114 and then checks whether or not the accumulated intersection count value reaches a predetermined reference number (e.g., 3 times) at step 1116. If, as a result of the check at step 1116, the accumulated intersection count value is found to not have reached the predetermined reference number (e.g., 3 times), the process returns to step 1102 in which subsequent processes are repeatedly performed.

If, as a result of the check at step 1116, the accumulated intersection count value is found to have reached the predetermined reference number (e.g., 3 times), the representative pattern determination unit 710 detects the corresponding pattern as a representative pattern at step 1118 and outputs the representative pattern. The representative pattern may be output as a coordinate value or a scale step.

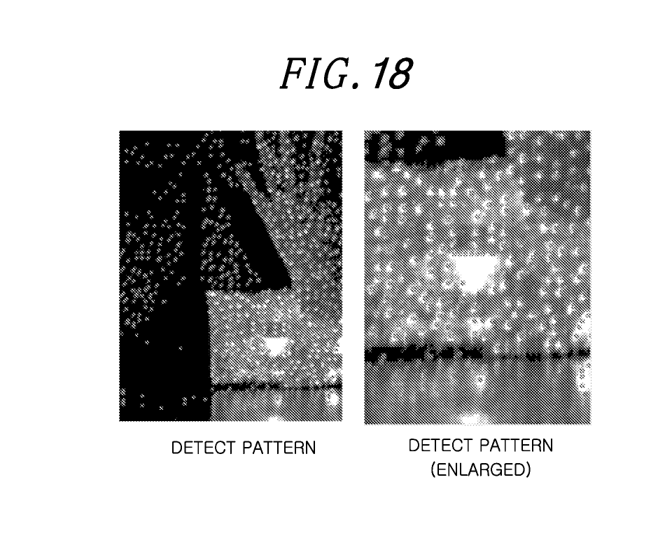

That is, the results output through step 1102 to step 1118 of FIG. 11 have a shape of a detection pattern not including an intersection area as shown in FIG. 18, for example. From an enlarge image on the right figure of FIG. 18, it can be seen that a single red box is indicated in each detected pattern and has been subject to intersection removal processing. Furthermore, the final results at step 818 of FIG. 8 have an arrangement of coordinates (x,y) at the center pointer of the red box and information on the size of the pattern (i.e., a step of scale down). The size of the arrangement means a total number of detected patterns.

As described above, a structural light method includes a process of photographing the results, obtained by projecting a pattern onto the object, using a camera at a position spaced apart from the object by a base line, extracting a pattern from the captured image, obtaining disparity, that is, a value shifted according to the distance by comparing the extracted pattern with the original pattern, and transforming the value into a 3-D depth. If the present invention is used, however, the performance (or reliability) of a process of extracting a pattern from a captured image can be effectively improved, and a pattern that is robust to a change of a projection distance, brightness, and an SNR can be extracted.

While the invention has been shown and described with respect to the preferred embodiments, the present invention is not limited thereto. It will be understood by those skilled in the art that various changes and modifications may be made without departing from the scope of the invention as defined in the following claims.

Accordingly, the scope of the present invention should be interpreted based on the following appended claims, and all technical spirits within an equivalent range thereof should be construed as being included in the scope of the present invention.

What is claimed is:

1. A method for extracting a pattern from an image, comprising:
a first process of transforming an input image into a current Modified Census Transform (MCT) coefficient;
a second process of configuring a current pattern window of the transformed current MCT coefficient;
a third process of calculating a Sum of Hamming Distance (SHD) value between the current pattern window and a reference pattern window of a previously registered template image by performing SHD calculation on the two pattern windows and comparing the calculated SHD value with a predetermined threshold;
a fourth process of extracting a corresponding pattern as a candidate pattern if, as a result of the comparison, the calculated SHD value is smaller than the predetermined threshold;
a fifth process of moving a center pointer of the current pattern window to a next pixel if, as a result of the comparison, the calculated SHD value is equal to or greater than the predetermined threshold and checking whether or not processing for all pixels of a current scale of the input image has been completed;
a sixth process of repeatedly performing the second process to the fifth process until the processing for all the pixels of the current scale is completed;
a seventh process of scaling down the input image in a predetermined ratio when the processing for all the pixels of the current scale is completed and checking whether or not processing for all scales of the input image has been completed;
an eighth process of repeatedly performing the first process to the seventh process until the processing for all the scales of the input image is completed; and
a ninth process of detecting a candidate pattern having a minimum SHD value as a representative pattern by comparing SHD values of stored candidate patterns with each other when the processing for all the scales of the input image is completed.

2. The method of claim 1, further comprising a process of removing image noise of the input image before transforming the input image into the current MCT coefficient.

3. The method of claim 1, wherein the first process comprises processes of:
transforming each of pixels of the input image into an MCT coefficient domain;
determining a block size of MCT calculation; and
generating the current MCT coefficient by performing MCT in such a way as to substitute coordinates of an MCT coefficient of a first pixel into a pixel pointer.

4. The method of claim 3, wherein a size of the current MCT coefficient is determined to be a size that satisfies both calculation speed and performance.

5. The method of claim 4, wherein a number of bits of the current MCT coefficient is determined by the block size of MCT calculation.

6. The method of claim 5, wherein the MCT calculation comprises outputting an MCT coefficient of 9 bits by performing MCT of a 3×3 size.

7. The method of claim 1, wherein the current pattern window is configured to have pattern features of the current MCT coefficient.

8. The method of claim 1, wherein the fourth process comprises storing a coordinate value, an SHD value, or a scale step of the candidate pattern.

9. The method of claim 1, wherein the eighth process comprises designating a first pixel at a left top of a scale image, generated through scale-down, as a pointer and repeatedly performing the first process to the seventh process.

10. The method of claim 9, wherein the eighth process is repeatedly performed until a scale image having a predetermined minimum size is output.

11. The method of claim 9, wherein the ninth process comprises processes of:
restoring a window size of each of detected candidate patterns to a size of an original image;
determining a maximum value ‘Max_left’ of x-axis values on a left side of two restored windows, a minimum value ‘Min_right’ of x-axis values on a right side of the two windows, a maximum value ‘Max_top’ of y-axis values at a top of the two windows, and a minimum value ‘Min_bottom’ of y-axis values at a bottom of the two windows;
checking whether or not a condition (‘Max_left’ Min_right) or (‘Max_top’>‘Min_bottom’) is satisfied;
calculating a size of an intersection area of the two windows if, as a result of the check, the condition is found to be not satisfied and comparing the size of the intersection area with a predetermined intersection ratio;
determining the two windows to be an identical pattern if, as a result of the comparison, the calculated size of the intersection area is found to be greater than the predetermined intersection ratio and determining a candidate pattern having a relatively small SHD value to be a final pattern; and
detecting a corresponding pattern as the representative pattern when a number of times that the final pattern has been determined reaches a predetermined reference number.

12. An apparatus for extracting a pattern from an image, comprising:
a noise removal block for removing image noise mixed with an input image;
a Modified Census Transform (MCT) block for transforming the input image from which the image noise has been removed into a current MCT coefficient;
a candidate pattern extraction block for calculating a Sum of Hamming Distance (SHD) value between a current pattern window of the transformed current MCT coefficient and a reference pattern window of a previously registered template image by performing SHD calculation on the two pattern windows until all pixels of a current scale of the input image are processed and extracting a candidate pattern by comparing the calculated SHD value with a predetermined threshold; and
a pattern detection block for scaling down the input image in a predetermined ratio when all pixels of the current scale are processed and detecting a candidate pattern having a minimum SHD value, of stored candidate patterns, as a representative pattern when processing for all scales of the input image is completed.

13. The apparatus of claim 12, wherein the MCT transform block comprises:
a domain transform unit for transforming each of the pixels of the input image into an MCT coefficient domain;
a block determination unit for determining a block size necessary for MCT calculation for the transformed MCT coefficient domain; and
a coefficient generation unit for generating the current MCT coefficient by performing MCT in unit of the determined block size.

14. The apparatus of claim 13, wherein the block determination unit determines the current MCT coefficient to have a size that satisfies both calculation speed and performance.

15. The apparatus of claim 14, wherein a number of bits of the current MCT coefficient is determined by the block size of MCT calculation.

16. The apparatus of claim 15, wherein the coefficient generation unit outputs an MCT coefficient of 9 bits by performing MCT of a 3×3 size.

17. The apparatus of claim 12, wherein the candidate pattern extraction block comprises:
a window configurator for configuring the current pattern window of the transformed current MCT coefficient;
an SHD calculator for calculating the SHD value between the two pattern windows by performing the SHD calculation on the current pattern window and the reference pattern window;
a candidate pattern extractor for extracting a corresponding pattern as a candidate pattern if the calculated SHD value is smaller than the predetermined threshold; and
a candidate pattern administrator for moving a center pointer of the current pattern window to a next pixel if the calculated SHD value is equal to or greater than the predetermined threshold and instructing SHD values to be calculated and candidate patterns to be extracted until all the pixels of the current scale of the input image are processed.

18. The apparatus of claim 17, wherein the window configurator configures the current pattern window having a size that comprises pattern features of the current MCT coefficient.

19. The apparatus of claim 12, wherein the pattern detection block comprises:
a scale-down executor for scaling down the input image in a predetermined ratio when the processing for all the pixels of the current scale is completed; and
a pattern detector for detecting the candidate pattern having the minimum SHD value as the representative pattern by comparing SHD values of the stored candidate patterns with each other when the scale-down processing for all the scales is completed.

20. The apparatus of claim 19, wherein the pattern detector comprises:
an image restoration unit for restoring a window size of each of detected candidate patterns to a size of an original image;
a reference value determination unit for determining a maximum value ‘Max_left’ of x-axis values on a left side of two restored windows, a minimum value ‘Min_right’ of x-axis values on a right side of the two windows, a maximum value ‘Max_top’ of y-axis values at a top of the two windows, and a minimum value ‘Min_bottom’ of y-axis values at a bottom of the two windows;
an intersection area calculation unit for calculating a size of an intersection area of the two windows if the maximum value ‘Max_left’ is smaller than the minimum value ‘Min_right’ or the maximum value ‘Max_top’ is smaller than the minimum value ‘Min_bottom’;
a final pattern determination unit for determining the two windows to be an identical pattern if the calculated size of the intersection area is greater than a predetermined intersection ratio and determining a candidate pattern having a relatively small SHD value to be a final pattern; and
a representative pattern determination unit for detecting a corresponding pattern as the representative pattern when a number of times that the final pattern has been determined reaches a predetermined reference number.
